(19) United States
(12) Patent Application Publication
(10) Pub. No.: US 2022/0402786 A1
(43) Pub. Date: Dec. 22, 2022

(54) PRODUCTION METHOD FOR FULL RESOURCE RECYCLING OF SULPHATE-PROCESS TITANIUM DIOXIDE PRODUCTION WASTEWATER

(71) Applicant: CHENGDU QIANLIJIN TECHNOLOGICAL INNOVATION CO., LTD., Chengdu (CN)

(72) Inventor: Jiazhu GONG, Chengdu (CN)

(21) Appl. No.: 17/891,236

(22) Filed: Aug. 19, 2022

Related U.S. Application Data
(63) Continuation of application No. PCT/CN2020/130588, filed on Nov. 20, 2020.

(30) Foreign Application Priority Data
Nov. 20, 2020 (CN) 202011311279.7

(51) Int. Cl. C02F 1/52; C02F 1/44; C02F 1/66

(52) U.S. Cl. CPC C02F 1/5236; C02F 1/441; C02F 1/66; C02F 2001/007

(57) ABSTRACT

The disclosure discloses a production method for full resource recycling of sulphate-process titanium dioxide production wastewater. The method comprises the steps: adding sulphate-process titanium dioxide production wastewater neutralized with lime and treatment wastewater obtained by separating gypsum in a filter press into a recycled sodium carbonate solution to precipitate saturated calcium sulfate in the treatment wastewater, clarifying slurry to separate a calcium carbonate precipitate from a sodium sulfate solution, and performing membrane separation on the separated sodium sulfate solution in a membrane filter; and adding lime into the concentrated phase sodium sulfate solution for causticizing reaction, wherein the filtrate is used as a sodium hydroxide solution, carbonizing using a carbon dioxide-containing tail gas produced in the production process of titanium dioxide to obtain a sodium carbonate solution, and then precipitating saturated calcium sulfate in the treatment wastewater again.

### CROSS-REFERENCE TO RELATED APPLICATIONS

This application is a continuation of International Patent Application No. PCT/CN2020/130588 with a filing date of Nov. 20, 2020, designating the United States, now pending, and further claims priority to Chinese Patent Application No. 202011311279.7 with a filing date of Nov. 20, 2020. The content of the aforementioned applications, including any intervening amendments thereto, are incorporated herein by reference.

### TECHNICAL FIELD

The disclosure relates to a production method of recycling of production wastewater, particularly to a production method for full resource recycling of sulphate-process titanium dioxide production wastewater.

### BACKGROUND OF THE PRESENT INVENTION

Sulphate-process titanium dioxide production wastewater mainly comes from a primary washing lotion, a secondary washing lotion and a lotion of metatitanic acid in the process of production, acidic washing wastewater generated when a gas is produced via acidolysis, a calcining tail gas spraying and absorbing water, sewage recycling drained water, floor rinsing water, equipment rinsing water, desalting water station regeneration wastewater and sporadic wastewater. The main pollutants in the produced wastewater include H₂SO₄, TiO₄, Fe²⁺, Fe³⁺, Na⁺ and a few amount and trace amount of harmful substances such as HSO₃⁻, F⁻ and Cl⁻. The chemical reaction principle of the existing wastewater treatment method is as follows:

CaO+H₂O→Ca(OH)₂ (1)

H₂SO₄+Ca(OH)₂→CaSO₄.2H₂O↓ (2)

FeSO₄+Ca(OH)₂+2H₂O→CaSO₄.2H₂O↓+Fe(OH)₂↓ (3)

FeSO₄+Ca(OH)₂+2H₂O+½O₂→Fe(OH)₃↓+CaSO₄.2H₂O↓ (4)

As shown in FIG. 1, different types of acidic wastewater from various production procedures enter a regulating reservoir for buffer regulation, and then are pumped to a neutralization reaction tank bubbled with air, stirred and oxidized for neutralization and oxidative aeration together with added lime slurry to generate a mixed precipitate of calcium sulfate dihydrate and iron hydroxide; the neutralized and oxidized slurry is fed to a filter press for solid-liquid separation, the separated filter cake is gypsum calcium sulfate containing iron oxide and a small amount of titanium oxide which is traditionally called “titanium gypsum” or “red mud”, and is sent out for utilization or stacked; the filtrate generated by filter press and a small amount of solids generated when initial filtration are filtered in a clarifying basin or fiber filter and then discharged to a natural water body as industrial wastewater meeting the national discharge standard. Since treatment water cannot be recycled, titanium dioxide industry access conditions stipulate that the emission load of each ton of sulphate-process titanium dioxide production wastewater must be less than 80 m³, although many innovative means of intermediate recycling, reuse and indiscriminate use have been adopted, such as indiscriminate use of primary and secondary washing water, the amount of each ton of titanium dioxide discharge treatment wastewater generated in the most effective production device is still about 60 m³.

The reason why such the large discharge amount of treatment wastewater cannot be recycled is that sulphate-process titanium dioxide production wastewater is treated by adopting the above lime neutralization reaction principle, the generated gypsum calcium sulfate is a precipitate with relatively large solubility, the saturated concentration of calcium sulfate in the treatment wastewater after gypsum is separated is large. The solubility product Ksp of calcium sulfate is 4.93×10⁻⁵ at 25° C., and each cubic meter of treatment wastewater after gypsum is separated contains about 2-4 kg of saturated calcium sulfate solution due to influences “salt effect” brought by temperatures and salt content. In addition to a small amount of treatment methods used for dissolving lime, the existing treatment methods are almost used for directly discharging to enter public water bodies, which not only wastes a lot of water resources but also affects water environment. However, the reason why recycling and reuse are not performed is that direct recycling is unfavorable to titanium dioxide production, which does not meet the standard of the traditional water treatment re-purifying recycling technology and economy. Its core reasons are as follows:

(1) If it is directly used in titanium dioxide production, two adverse conditions are generated.

First, the generated wastewater is used as spraying, cooling and recycling water, with the increase of the evaporation cycle concentration, a large amount of calcium sulfate is precipitated out due to excessive saturation concentration and the absorption of sulfur oxide in an acid gas, and the generated precipitate can block pipelines and systems so that production cannot be continuously performed. Hence, it cannot be used at all.

Second, the generated wastewater is used as metatitanic acid lotion which consumes the most water in sulphate-process titanium dioxide production. Similarly, due to the high concentration of liquid holdup of sulfuric acid in metatitanic acid, the “common ion effect” is generated, so that the saturated concentration of calcium sulfate exceeds, and a large amount of calcium sulfate is precipitated and adsorbed on metatitanic acid, introduction of such the metatitanic acid into calcining of products not only affects the content of titanium dioxide but also seriously influences the pigment property of titanium dioxide; meanwhile, the filter cloth of a filtering medium is scaled; the existing filter cloth is soaked, washed and regenerated with hydrofluoric acid, which cannot remove calcium sulfate scales; hence, it cannot be used at all.

(2) If it is recycled after soft water purification, it is also economically and technically unacceptable.

First, an ion exchange method is used to treat the raw water, and the ton of titanium dioxide is calculated as 60 cubic meters, wherein about 240 kg of saturated calcium sulfate needs to be removed, and soluble sulfates brought by manufacturing rutile seeds and posttreatment coating are present, so it is needed to use a corresponding equivalent of table salts and hundreds of kilograms of anion-cation exchange agent raw materials such as hydrochloric acid and sodium hydroxide, a large amount of strong brine containing calcium chloride is still discharged after exchange, in this way, economic cost is expensive, the weight of discharge salts is doubled, environment is difficult to accept, and lots of chemical substance resources are wasted.

Second, treatment wastewater is separated by directly using a reverse osmosis membrane according to the conventional raw water treatment.

When the concentration of strong brine generated after membrane separation exceeds the saturated concentration of calcium sulfate, calcium sulfate is precipitated out; due to high concentration and low surface energy of the membrane surface but low surface energy of a crystal core (precursor) precipitated from saturated calcium sulfate, saturated calcium sulfate is deposited and scaled on the membrane to prevent water molecules from passing and reducing the efficiency of membrane separation, causing frequent washing, difficult regeneration, blocking and scrapping of the reverse osmosis membrane during the short operation period, large investment and high operation cost. For example, “treatment method of titanium dioxide wastewater” described in Chinese patent publication No. CN106315910A, in which a flocculant aluminum trichloride is added in treatment wastewater to flocculate ultra-fine suspended matters and then ultrafiltration is carried out. Furthermore, to prevent saturated calcium sulfate and other substances are deposited when reverse osmosis crystallization, it is needed to add a scale inhibitor; the content of calcium sulfate in treatment wastewater is up to 4000 mg/L, the calculated calcium ion content is close to 1200 mg/L, a large amount of expansive scale inhibitors are needed, which not only increases the reuse cost of wastewater treatment, but also affects the use of recycled water due to the presence of the scale inhibitor or even creates the quality influence of the titanium dioxide production product, such as phosphorus scale inhibitors and an aluminum trichloride flocculant are enriched in metatitanic acid entering titanium dioxide production from reused water, titanium dioxide microcrystal particles with pigment property cannot be calcined in a rotary kiln, the quantity and instability of phosphorous and aluminum can cause the inferior quality of titanium dioxide because they are both control agents for controlling the particle size and crystal form of the produced titanium dioxide; if an organic complexing agent, because the molecular weight of the complexing agent is far larger than the molecular weight of water and a pore diameter of membrane separation, the pores of the membrane are blocked, and similarly the separation efficiency is reduced, or even the scrapping of the membrane material is caused in a short period of time. In addition, the produced concentrated phase brine is still unused due to low concentration and discharged, which does not reduce the absolute discharge amount of solute in water and then affect the environment.

Third, ultrafiltration is performed before membrane separation. Ultrafiltration is only effective to ultra-fine solid particles, but it is not significant to saturated solutions or even supersaturated solutions; because the saturated concentration of calcium sulfate in the treatment wastewater after gypsum separation is relatively large, once ultrafiltration and membrane separation are subject to changes in pressure, temperature, fluid convection, surface friction and surface energy, a precipitate is separated out to block the water molecule and ion passageways of the ultrafiltration medium and the membrane so that separation is difficult.

Fourth, in U.S. Pat. No. 4,966,710, sodium hydroxide is used to adjust the pH value of the sodium sulfate solution to precipitate magnesium and calcium in the solution, the sodium sulfate solution for purification reduces the chemical regeneration agent used in ion exchange and regeneration instead of using sodium carbonate to precipitate impurities in the solution; in U.S. Pat. No. 6,086,842, desulfurated tail gas is used to produce high-quality calcium sulfite-free desulfurated gypsum, sodium, sulfate is used for causticizing and cyclic absorption, carbon dioxide in the production is not utilized to produce sodium carbonate.

Therefore, this is also the “problem” that the existing sulphate-process global titanium dioxide wastewater treatment cannot be economically recycled. The only way is to take the negative method of discharging water. Therefore, it is caused that the consumption of raw water for production is large, the utilization rate of water resources is low, and the external drainage is amazing, the environment is affected and the requirements of green and sustainable development is not met. However, sulphate-process titanium dioxide production wastewater is treated by using carbon dioxide resource by coupling the existing sulphate-process titanium dioxide production with lime raw material causticizing solution and wastewater treatment so as to reduce the content of the calcium ion in the saturated calcium sulfate solution in treatment wastewater after separated gypsum is removed so that it returns back to the gypsum. Utilization of production coupling and its own waste resources is conducive to full resource recycling of membrane separation and treatment wastewater, and reduces the purchase cost of commercial reagents, solves the technical difficulty that the sulphate-process titanium dioxide neutralization treatment wastewater is difficultly recycled, saves the consumption of raw water resources in production, and eliminates the factors affecting the environmental water body caused by the discharge of the existing neutralization treatment wastewater; the strong brine after membrane separation is causticized using lime, sodium resources and low alkaline chemical energy are recovered, and there are no reports about production process and technologies for full coupling and recycling of wastewater resources.

### SUMMARY OF PRESENT INVENTION

In order to solve the technical and economic problems that the existing sulphate-process titanium dioxide production wastewater cannot be recycled and reused, carbon dioxide resource in a tail gas discharged by sulphate-process titanium dioxide production, a lime causticizing solution and wastewater treatment device are utilized to carry out coupling production of mass flow and chemical energy flow, thereby overcoming the problems and shortcomings that the neutralized sulphate-process titanium dioxide production wastewater is difficult to recycle and economically utilize, eliminating the influence factors of the discharge of the existing treatment wastewater on environmental water bodies and saving a lots of raw water resources used for production; the objective of the disclosure is to provide a production method for full resource recycling of sulphate-process titanium dioxide production wastewater. The method is as follows: sulphate-process titanium dioxide production wastewater together with treatment wastewater after gypsum is precipitated and separated with limestone and lime are added into a recycled itself-made sodium carbonate solution to precipitate saturated calcium sulfate (including calcium carbonate and sodium sulfate slurry) left in wastewater due to separation of gypsum; the precipitate reaction material slurry solution is clarified to separate calcium carbonate slurry from the sodium sulfate solution. The clarified and separated calcium carbonate thick slurry, as a calcium carbonate resource, is recycled and returned back to titanium dioxide wastewater neutralization, and the separated sodium sulfate solution is subjected to membrane separation via a reverse osmosis membrane. A diluted phase (purified water) obtained by membrane separation, as process water, is returned back to titanium dioxide production to replace an externally supplied raw water resource used in production. Lime is added into a strong brine solution containing sodium sulfate obtained by membrane separation for causticizing reaction to generate a calcium sulfate precipitate and sodium hydroxide solution slurry, and then the slurry is separated by filter press; the separated calcium sulfate filter cake is recycled and returned back to titanium dioxide wastewater neutralization and precipitation calcium sulfate slurry, and the separated together with neutralization and precipitation wastewater gypsum; a part of separated sodium hydroxide solution, as an alkaline absorption solution, is returned back to titanium dioxide production to wash the acidolysis and calcining acidic tail gas, and the other part is carbonized by utilizing carbon dioxide in the titanium dioxide production tail gas to carbonize sodium hydroxide into the sodium carbonate solution which provides carbonate ion substances for removing saturated calcium sulfate in treatment wastewater to form a calcium carbonate precipitate and is recycled to return back to treatment wastewater to precipitate calcium ions in saturated calcium sulfate solution; the coupling and recycling of sulphate-process titanium dioxide wastewater is achieved. Compared with the existing direct wastewater discharge technology after neutralization treatment, the production method of full resource coupling utilization of sulphate-process titanium dioxide production not only solves the full recycling of the titanium production wastewater but also saves the need on a lot of raw materials for titanium dioxide production, thereby achieving the reuse of production water and great emission reduction of wastewater; furthermore, the wastewater treatment process is optimized, and production cost of wastewater treatment is saved; since low lime chemical energy is used to causticize the strong brine obtained after membrane separation, thereby reducing the expense of sodium hydroxide for titanium dioxide production and achieving the maximum resource utilization. The utilization rate and reuse rate of resources are improved, and the economic benefits of producers are increased, thereby achieving the technical and economic purpose of full recycling of sulphate-process titanium dioxide production wastewater.

The production principle of the invention is as follows:

H₂SO₄+CaCO₃+H₂O→CaSO₄.2H₂O↓+CO₂↑ (5)

H₂SO₄+Ca(OH)₂→CaSO₄.2H₂O↓ (6)

CaSO₄.2H₂O→Ca²⁺+SO₄⁻²+2H₂O (7)

Na₂CO₃+CaS_{O4}→Na₂SO₄+CaCO₃↓ (8)

Na₂SO₄+Ca(OH)₂+2H₂O→2NaOH+CaSO₄.2H₂O↓ (9)

2NaOH+CO₂—>Na₂CO₃+H₂O (10)

As shown in reaction equations (5) and (6), the solubility product Ksp of calcium sulfate generated by neutralization of sulphate-process titanium dioxide production wastewater and limestone and lime milk is 4.93×10-5. After the calcium sulfate is used as a gypsum calcium sulfate dihydrate filter cake after separation via filter press, there is still saturated calcium sulfate ions in the solution, as shown in ionization equation (7), calcium ions and sulfate ions. Once the concentration of the solution changes and the concentration of sulfate is increased, calcium sulfate dihydrate solid is precipitated out and cannot be directly reused and utilized. As shown in reaction equation (8), there is only a few of sodium carbonate in the solution, saturated calcium sulfate generates a sodium sulfate solution and a calcium carbonate precipitate, the solubility product Ksp of generated calcium carbonate precipitate is 4.8×10⁻⁹, that is, four orders of magnitude different by a factor of 10′, in which the calcium ion concentration is far away from the saturated concentration of calcium sulfate. The solution obtained by separating the precipitate calcium carbonate is subjected to membrane separation via the reverse osmosis membrane, the diluted phase obtained after membrane separation, as purified process water, is returned back to titanium dioxide production, and the concentrated phase obtained after membrane separation is added with lime according to reaction equation (9) for causticizing to obtain a sodium hydroxide solution and a calcium sulfate dihydrate precipitate; the sodium hydroxide solution obtained after the calcium sulfate dehydrate is separated is used to absorb a tail gas generated by titanium dioxide posttreatment drying and burning fuel or a carbon dioxide gas as shown in reaction formula (5) generated when the calcium sulfate precipitate is neutralized with limestone, carbonizing reaction is carried out according to reaction equation (10) to obtain a sodium carbonate solution, the obtained sodium carbonate solution is recycled and returned back to reaction equation (8) for removing saturated calcium sulfate in wastewater neutralization filtrate.

The technical solution of the disclosure is as follows:

sulphate-process titanium dioxide production wastewater is added into a neutralization reaction tank, then limestone and lime milk are added in stages and air is introduced, the above materials are subjected to neutralization, precipitation and oxidation reaction, the slurry precipitated by reaction is fed to a filter press (1) for filter press separation. A filter cake obtained by filter press separation as titanium gypsum is fed to cement and other building materials to be used; a separated filtrate as treated wastewater is fed to a precipitation tank, a sodium carbonate solution returning back from a carbonizing tower and calcium carbonate recycling returning slurry obtained after saturated calcium sulfate is precipitated are added to jointly precipitate calcium in saturated calcium sulfate in the solution. The material for precipitating calcium carbonate is fed into a clarifying tank (1) for clarification; a part of the clear thick slurry returns back to the neutralization reaction tank to replace a part of lime milk neutralization wastewater, and the clarified clear solution is fed into a membrane filter for membrane separation; a diluted phase obtained after membrane separation as purified water returns back to titanium dioxide production to replace originally supplied process water; the concentrated phase obtained after membrane separation s fed into a causticizing tank in which lime milk is added for multi-stage causticizing; the causticized material is fed into a filter press (2) for filter press, the separated filter cake returns back to wastewater neutralization reaction tank and neutralized slurry; a part of the separated filtrate as a sodium hydroxide solution is fed into the carbonizing tower for carbonizing with carbon dioxide in the produced tail gas, the carbonized solution is fed into the precipitation tank to precipitate calcium carbonate; the other part returns back to titanium dioxide production to replace a purchased alkaline raw material.

Compared with the existing titanium dioxide wastewater treatment production technology by sulfuric acid method, the production method of full resource coupling and utilization of sulphate-process titanium dioxide wastewater not only solves the full recycling of titanium dioxide production wastewater, but also saves the need for a large amount of raw water for titanium dioxide production, thereby achieving the reuse of production water and great emission reduction of wastewater. Furthermore, the wastewater treatment production process is optimized, waste resource carbon dioxide in the titanium dioxide production tail gas is fully utilized so as to save the production of wastewater treatment; since low lime chemical energy is used to causticize and recover the strong brine after membrane separation, the amount of sodium hydroxide required for titanium dioxide production is reduced so as to achieve maximum resource utilization. The utilization rate and reuse rate of resources are improved, and the economic benefits of producers are increased, thereby achieving the technical and economic purpose of coupling and full resource recycling of titanium sulfate production wastewater.

As preference, the wastewater is sulphate-process titanium dioxide production wastewater and treatment wastewater containing calcium sulfate.

As preference, the neutralizers comprise alkaline calcium raw materials such as lime, limestone and acetylene production carbide slag, preferably limestone and lime.

As preference, the neutralization reaction tank can be a single reactor with a stirrer, or multiple tandem reactors with stirrers.

As a preference, the neutralization reaction tank is preferably multiple tandem reactors with stirrers, and the neutralization pH is controlled according to different stages, and the pH is controlled at 6.0-8.0, preferably 7.0-7.5, from low to the last stage.

As preference, the filter press for separating gypsum is an ordinary commercially available filter press with diaphragm press, which is preferably equipped with a back blowing central hole system and a compressed air central filter cake drying system.

As preference, the precipitation tank can be a single reactor with a stirrer, or multiple tandem reactors with stirrers; preferably more than two reactors.

As preference, the carbonizing solution is added into the precipitation tank to precipitate calcium carbonate, and thick slurry as crystal seeds can be added or not added in the clarifying tank; preferably, thick slurry is added as crystal seeds.

As preference, a molar ratio (M_{Na2CO3}/M_{CaSO4}) of the addition amount of the sodium carbonate solution to the amount of saturated calcium sulfate is 1.0-1.2, preferably 1.05-1.10, and a ratio (M_{crystal}/M_{generated}) of added thick slurry crystal seeds to generated calcium carbonate is 1-3, preferably 1.5-2.

As a preference, the clarifying tank (1) can adopt a continuous clarifying tank and a parallel semi-continuous clarifying tank used alternately, and the clarifying retention time is 1-3 h, preferably 1.0-1.5 h.

As preference, the membrane filter uses a reverse osmosis membrane filter separator which can be of single stage or multiple stages. The multi-stage reverse osmosis membrane filter separator is used for three washing of titanium dioxide posttreatment, and the rest is preferably is the single stage. The initial pressure of membrane filtration is 1-2 MPa, preferably 1.5 MPa; and the final pressure is 4-5 MPa, preferably 4.5 MPa. The concentration multiple of treatment wastewater is 6-15 times, preferably 8-10 times.

As preference, the conductivity of the diluted phase (purified water) obtained after membrane separation is 60-120 us/cm, preferably 80-100 us/cm, which is directly returned back to titanium dioxide production process water.

As preference, the causticizing tank adopts multi-stage tandem causticization with the number of stages being 2-5, preferably more than 3. A molar ratio of lime milk to sodium sulfate (M_{Ca(OH)2}/M_{Na2SO4}) added for causticizing is 1.1-1.4, preferably 1.15-1.25.

As preference, the filter cake separated by the filter press (2) returns back to the neutralization reaction tank to reacts with the neutralization slurry; a part of the filtrate, as a causticizing alkaline solution, is returned to titanium dioxide production, and the other part of filtrate is fed to the carbonizing tower for carbonizing; the distribution proportion is determined depending on the amount of saturated sulfuric acid that needs to be eliminated in treatment wastewater.

As preference, the carbon dioxide gas used for carbonizing in the carbonizing tower can be a tail gas dried after titanium dioxide production, a metatitanic acid rotary kiln calcining tail gas and a carbon dioxide gas produced when wastewater is neutralized with calcium carbonate (limestone), a tail gas produced when fuel is combusted and a boiler tail gas produced in a boiler; and a carbonizing degree is controlled at the pH of 11.5-12.5, preferably 12.

Compared with the prior art, the disclosure has the following principle and beneficial effects:

the sulphate-process titanium dioxide production wastewater and treatment wastewater obtained after the reaction precipitate is neutralized with lime and the gypsum is separated in the filter press are added into the recycled sodium carbonate solution to precipitate calcium ions in saturated calcium sulfate solution, and treatment wastewater solution mainly containing sodium sulfate is replaced and obtained. The treatment wastewater solution is filtered and purified using the membrane filter. The purified water obtained by membrane filtration, as process water, returns back to titanium dioxide production to be recycled, and the treatment wastewater is not discharged; lime is added into the concentrated sodium solution obtained by membrane filtration and separation for multi-stage causticizing to obtain the sodium hydroxide solution; the sodium hydroxide solution is carbonized using carbon dioxide in a titanium dioxide production waste gas to obtain the sodium carbonate solution, the sodium carbonate solution returns back to the precipitation tank to precipitate saturated calcium sulfate in treatment wastewater, achieving the purpose of full resource coupling and recycling of sulphate-process titanium dioxide production wastewater.

The method of the disclosure utilizes the carbon dioxide resource in the existing sulphate-process titanium dioxide production to couple with lime causticizing solution and wastewater treatment, so as to solve the technical problem that neutralization of saturated calcium sulfate in sulphate-process titanium dioxide and treatment wastewater is difficult to recycle for a long time, eliminate the existing influence factor for discharging the neutralization treatment wastewater, saving the lots of raw water used for production and saving water resources.

Due to the use of all element resources in wastewater and mass flow and chemical energy flow in wastewater treatment and titanium dioxide production, large cycle of titanium dioxide production and wastewater treatment and a small cycle in wastewater treatment are adopted, which not only solves the technical problem of recycling of sulphate-process titanium dioxide production wastewater but also greatly reduces the water consumption per unit of titanium dioxide production, thereby achieving the coupled utilization and reuse of all resources in wastewater, saving the use amount of resources and increasing the economic benefits of producers. Energy saving and consumption reduction is significant, and economic benefits are also significant. Therefore, the disclosure not only innovates the utilization of resources for recycling and coupling of the sulphate-process titanium dioxide production wastewater, but also greatly reduces the resource cost and wastewater discharge water cost, thereby improving the economic and social benefits of production, and solving the technical problem that the traditional process cannot be recycled and economically utilized.

### DESCRIPTION OF THE DRAWINGS

FIG. 1 is a process flowchart of traditional sulphate-process titanium dioxide production wastewater.

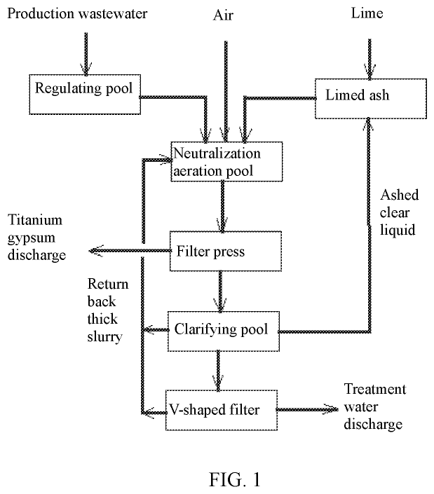

FIG. 2 is a process flowchart of full resource recycling of sulphate-process titanium dioxide production wastewater of the disclosure.

### DETAILED DESCRIPTION OF PREFERRED EMBODIMENTS

### Example 1

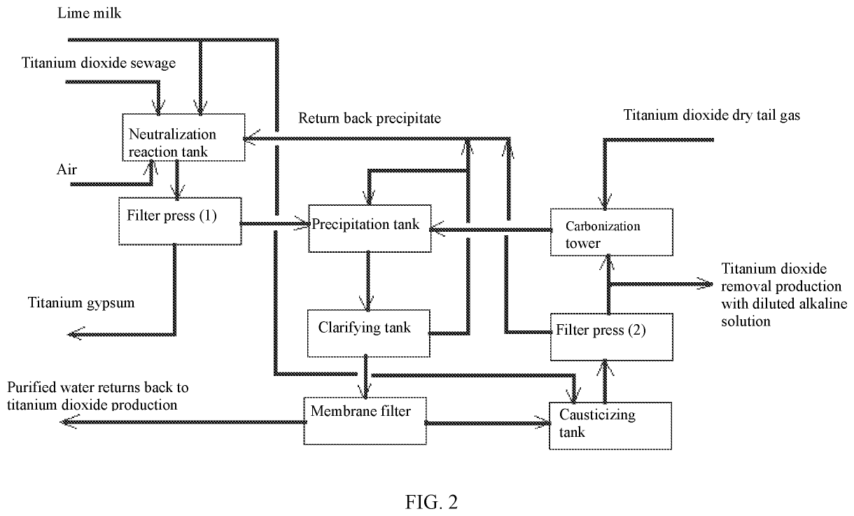

As shown in FIG. 2, 1600 L per hour of acidic wastewater (specific gravity of 1.05, containing 36.96 g/L of sulfuric acid, 16.80 g/L of ferrous sulfate, 0.525 g/L of titanium sulfate, see Table 1) and 29.0 L per hour of lime milk containing 179 g/L calcium oxide were neutralized in three tandem 2000 L neutralization tanks with stirrers and equipped with air distribution tubes at the bottoms in which air was blown for aerated oxidation, the retention time of reaction materials was controlled for 1 h, the pH value of slurry was controlled to 7.5, the slurry overflew from the top of the third-stage neutralization reaction tank to enter a filter press pump tank and then was continuously fed into the filter press for filtration and separation, so as to obtain 27.4 kg of filter cake containing 45% water and 1658 L of treatment wastewater (specific gravity of 1.005, its compositions are seen in Table 2) in each hour.

TABLE 1
Compositions of titanium dioxide production wastewater

| Component | Concentration (g/L) | Component | Content (%) |
|---|---|---|---|
| H₂SO₄ | 36.96 | MgSO₄ | 2.10 |
| FeSO₄ | 16.80 | Al₂(SO₄)₃ | 1.05 |
| Na₂SO₄ | 1.30 | CaSO₄ | 1.05 |

TABLE 2
Compositions of treatment wastewater

| Component | Concentration (g/L) | Component | Content (%) |
|---|---|---|---|
| pH | 7.2 | MgSO₄ | 0.010 |
| FeSO₄ | 0.001 | Al₂(SO₄)₃ | 0.010 |
| Na₂SO₄ | 1.25 | CaSO₄ | 3.35 |

1658 L per hour of treatment wastewater was continuously fed into a 5500 Ld saturated calcium sulfate precipitation tank, and meanwhile 146 L of 30 g/L carbonized sodium carbonate solution and 33 L of 250 g/L clarified calcium carbonate thick slurry that was recycled and returned back were added in each hour, the precipitation reaction material was stayed for 1 h and then continuously fed into a clarifying tank (1) for clarification to obtain 50 L of 250 g/L calcium carbonate thick slurry, 33 L of calcium carbonate thick slurry was returned back into the precipitation tank, crystal seeds were provided, 17 L of calcium carbonate thick slurry was recycled and returned back to an acidic wastewater neutralization reaction tank.

The clear solution from the clarifying tank (1) was fed into a 1814.2 L membrane separation device in each hour to be separated, an initial filtration pressure was 1.5 MPa, and reverse rinsing cyclic filtration was performed after 4.5 MPa of filtration pressure was reached. 1636 L of purified water and 178 L of enriched strong brine were separated from the membrane filter. The compositions of feed water, purified water and strong brine after membrane separation are seen in Table 3. The concentration of sodium sulfate in the feed water is 3.49 g/L, the concentration of the purified water is only 16 mg/L, the conductivity is 107 us/cm, the concentration of sodium sulfate in the strong brine is increased to 34.72 g/L, and the conductivity is 98000 us/cm. The rate of water recycling and returning back to titanium dioxide production is 90%.

TABLE 3
Compositions of feed water after membrane separation

| | Concentration | Concentration | Concentration |
|---|---|---|---|
| | of feed | of purified | of strong |
| Component | water (g/L) | water (g/L) | brine (g/L) |
| pH | 7.6 | 7.2 | 7.8 |
| Na₂SO₄ | 4.66 | 0.016 | 42.60 |
| MgSO₄ | 0.005 | — | |
| CaSO₄ | — | — | — |
| Conductivity (us/cm) | 9000 | 107 | 98000 |

178 L per hour of strong brine after membrane separation was fed into 3-stage causticizing tank with a stirrer, 4.3 L of 170 g/L lime milk was added into each of 3 stages for causticizing for 13.1 L in total, each of the materials was stayed for 30 min respectively for 1.5 h in total. The causticized slurry was fed into the filter press (2) to undergo filter press, so as to separate 16.80 kg of filter cake containing 45% water and 178.6 L of filtrate containing 20/l g/L sodium hydroxide. The filtrate was carbonized with the titanium dioxide dry tail gas to obtain 180 L of solution containing 26.43 g/L sodium carbonate, wherein 166 L of solution was recycled and returned back to the precipitation tank to precipitate a saturated calcium sulfate solution, the rest 14 L of solution was used for washing of other acidic gases to replace the original commercial sodium hydroxide solution.

### Example 2

As shown in FIG. 2, 240 m³ per hour of acidic wastewater (main compositions are seen in Table 4) from sulphate-process titanium dioxide production and 36.5 m³ per hour of lime milk containing 200 g/L calcium oxide were neutralized in four tandem 180 m³ neutralization tanks with stirrers, the bottoms of the last two stages of neutralization reaction tanks were provided with air distribution tubes and blown with air for aerated oxidation, the retention time of reaction materials was controlled for 1.5 h, the pH value of slurry was controlled to 7.5, the slurry overflew from the top of the four-stage neutralization reaction tank to enter a filter press pump tank and then was continuously fed into the filter press for filtration and separation, so as to obtain 45.5 t of filter cake containing 45% water and 253 t of treatment wastewater in each hour. The compositions are seen in Table 5.

TABLE 4
Compositions of titanium dioxide production wastewater

| Component | Concentration (g/L) | Component | Content (%) |
|---|---|---|---|
| H₂SO₄ | 41.06 | MgSO₄ | 1.10 |
| FeSO₄ | 18.66 | Al₂(SO₄)₃ | 0.95 |
| Na₂SO₄ | 1.54 | CaSO₄ | 1.55 |

TABLE 5
Compositions of treatment wastewater

| Component | Concentration (g/L) | Component | Content (%) |
|---|---|---|---|
| pH | 7.0 | MgSO₄ | 0.010 |
| FeSO₄ | 0.001 | Al₂(SO₄)₃ | 0.010 |
| Na₂SO₄ | 1.46 | CaSO₄ | 3.65 |

253 t per hour of treatment wastewater was continuously fed into 3 tandem 110 m³ saturated calcium sulfate precipitation tank, and meanwhile 4.6 m³ of 300 g/L clarified slurry returned back by circulating calcium carbonate and 22 m³ of 35.6 g/L carbonized sodium carbonate solution, the precipitation reaction material was stayed for 1 h and then continuously fed into a clarifying tank (1) for clarification to obtain 6.8 m³ of 300 g/L calcium carbonate thick slurry, 4.6 m³ of calcium carbonate thick slurry was returned back into the precipitation tank, crystal seeds were provided, 2.2 m³ of calcium carbonate thick slurry was recycled and returned back to a wastewater neutralization reaction tank.

278 m³ per hour of clarified solution from the clarifying tank (1) was fed into a membrane separation device with a membrane separation area of 5000 m². The volume of the separated purified water is 255 m³ in each hour, and the volume of the enriched strong brine is 23 m³. Compositions of membrane separation feed water, separated and purified water and strong brine are seen in Table 3. The concentration of sodium sulfate in the feed water is 4.80 g/L, the concentration of the purified water is only 20 mg/L, the conductivity is 113 us/cm, the concentration of the strong brine is increased to 57.98 g/L, and the conductivity is 98000 us/cm. The rate of water recovered and returned back to titanium dioxide production is 90%.

TABLE 3
Compositions of membrane separation feed water

| | Concentration | Concentration | Concentration |
|---|---|---|---|
| | of feed | of purified | of strong |
| Component | water (g/L) | water (g/L) | brine (g/L) |
| pH | 7.5 | 7.2 | 7.6 |
| Na₂SO₄ | 4.80 | 0.016 | 57.98 |
| MgSO₄ | 0.005 | — | |
| CaSO₄ | — | — | — |
| Conductivity | 10000 | 113 | 98000 |
| (us/cm) | | | |
| Conductivity | 9000 | 107 | 98000 |
| (us/cm) | | | |

23 m³ of strong brine after membrane separation was fed into 5-stage tandem 15 m³ causticizing tank with a stirrer, 0.63 m³ of 200 g/L lime milk containing CaO was added into each of 5 stages for causticizing for 3.16 L in total, each of the materials stayed for 30 min respectively for 2.5 h in total. The causticized slurry was fed into the filter press (2) to undergo filter press, so as to separate 3.5 t of filter cake containing 50% water and 21 m³ of filtrate containing 29.4 g/L sodium hydroxide. 2.6 m³ of filtrate was returned back for titanium dioxide production, the rest 18.4 m³ of filtrate was carbonized with titanium dioxide dry tail gas to obtain 20.1 m³ of 35.60 g/L solution which was recycled and returned back to the precipitation tank to precipitate the calcium sulfate solution.

We claim:

1. A production method for full resource recycling of sulphate-process titanium dioxide production wastewater, comprising:
adding sulphate-process titanium dioxide production wastewater together with limestone and lime into a neutralization reaction tank for precipitation reaction, and feeding completely precipitated reaction materials into a filter press for filtration and separation; and feeding a separated filter cake as titanium gypsum into a gypsum building material and a cement building material to be used, and performing processing production of full recycling of a separated filtrate as treated wastewater;
adding wastewater after being separated in the filter press into a precipitation tank and meanwhile adding a sodium carbonate solution from a carbonizing tower, controlling the reaction to precipitate saturated calcium sulfate in the treatment wastewater so that a calcium carbonate precipitate material with a smaller solubility is generated, and then feeding the precipitate material into a clarifying tank to be clarified; turning a heavy phase substrate calcium carbonate slurry back to the neutralization reaction tank to undergo neutralization reaction with wastewater fed in titanium dioxide production; and feeding a light phase clear liquid from the clarifying tank into a membrane separator for membrane separation of a saline solution, turning a diluted phase (purified water) generated after membrane separation as process water back to a titanium dioxide production procedure, thereby saving externally supplied raw water resources and achieving full utilization of wastewater;
feeding a concentrated phase sodium sulfate solution generated after membrane separation into a causticizing tank, then adding lime milk, allowing the above materials to undergo causticizing reaction to generate a precipitate calcium sulfate and a sodium hydroxide solution, feeding causticized slurry into the filter press for separation, and returning a separated filter cake back to the lime neutralization reaction tank to be neutralized together with titanium dioxide wastewater; and feeding a separated filtrate as the sodium hydroxide solution into the carbonizing tower to be carbonized with a carbon dioxide-containing tail gas generated in the titanium dioxide production process so that the sodium hydroxide solution is converted into a sodium carbonate solution, and then recycling the sodium carbonate solution to the precipitation tank to precipitate calcium ions of saturated calcium sulfate in treatment wastewater; and
returning a part of filtrate back to the titanium dioxide production to serve as a diluted alkaline solution, depending on the mass flow of the causticized and separated solution.

2. The production method for full resource recycling of sulphate-process titanium dioxide production wastewater according to claim 1, wherein the production wastewater is production wastewater which is used for sulphate-process titanium dioxide production and needs neutralization treatment; and the pH value of lime neutralization reaction is 6-8, preferably 7.0-7.5.

3. The production method for full resource recycling of sulphate-process titanium dioxide production wastewater according to claim 1, wherein the treatment wastewater is treatment wastewater produced after titanium dioxide production wastewater is neutralized with limestone and lime and a gypsum filter cake is separated via the filter press (1), wherein the treatment wastewater contains a saturated calcium sulfate solution and a few amount of soluble sulfate impurity solution, and the concentration range of saturated calcium sulfate is 1-5 g/L, namely, 1-5 Kg/m³.

4. The production method for full resource recycling of sulphate-process titanium dioxide production wastewater according to claim 1, wherein the sodium carbonate solution from the carbonizing tower is added into the precipitation tank, and a molar ratio (M_{Na2CO3}/M_{CaSO4}) of the addition amount of the sodium carbonate solution to the amount of saturated calcium sulfate is 1.0-1.2, preferably 1.05-1.10, and a ratio (M_{crystal}/M_{generated}) of added thick slurry crystal seeds to generated calcium carbonate is 1-3, preferably 1.5-2.

5. The production method for full resource recycling of sulphate-process titanium dioxide production wastewater according to claim 1, wherein the clarifying time of the clarifying tank (1) is 1-3 h, preferably 1.5-2.0; the amount of the thick slurry recycling and returning back to the precipitation tank is ⅔ of the total amount, which serves as crystal seeds for precipitating calcium carbonate; the thick slurry whose amount is ⅓ of the total amount is recycled and returns back to the neutralization reaction tank to react with titanium dioxide production wastewater; and the clear liquid part is fed to a membrane separation filter.

6. The production method for full resource recycling of sulphate-process titanium dioxide production wastewater according to claim 1, wherein the clear liquid separated via the clarifying tank (1) is fed to a reverse osmosis membrane separation device containing a pretreatment system and a reverse osmosis system supplemented with dosing, washing, back washing and the like for membrane separation; after a starting pressure for membrane filtration is 1.5 MPa, a final pressure is 4-5 MPa, preferably 4.5 MPa, back washing is performed, and the concentration multiple of the treatment wastewater is 6-15 folds, preferably 8-10 folds; the purified water produced after membrane separation directly returns back to titanium dioxide production for recycling as process water; and strong brine produced after membrane separation is a sodium sulfate solution, which is used for eliminating saturated calcium sulfate in treatment wastewater as causticized sodium hydroxide and sodium carbonate solutions, or is concentrated for enrichment again.

7. The production method for full resource recycling of sulphate-process titanium dioxide production wastewater according to claim 1, wherein the membrane separation and filtration can adopt multi-stage and single-stage separation; multi-stage separation water can be used in titanium dioxide posttreatment process; preferably, the conductivity of the diluted phase (purified water) generated after membrane separation is 60-120 us/cm, preferably 80-100 us/cm; the purified water directly returns back to titanium dioxide production process water; and the concentrated phase generated after membrane separation is the sodium sulfate solution, which is fed to the causticizing tank for reaction.

8. The production method for full resource recycling of sulphate-process titanium dioxide production wastewater according to claim 1, wherein the causticizing tank adopts tandem multi-stage causticizing with the number of stages being 2-5, preferably more than 3; a molar ratio (M_{Ca(OH)2}/M_{Na2SO4}) of lime milk to sodium sulfate added for causticizing is 1.1-1.4, preferably 1.15-1.25; and dosing distribution of line milk is performed based on the number of stages for causticizing.

9. The production method for full resource recycling of sulphate-process titanium dioxide production wastewater according to claim 1, wherein the causticizing materials comprise calcium sulfate generated by causticizing and calcium hydroxide which does not involve in reaction, which are fed into a filter press (2) for filter pressing, the filter cake is pulped and recycled to return back to the neutralization reaction tank, the filtrate is shunt depending on the total amount of sodium hydroxide and the amount of saturated calcium sulfate needing to be precipitated, a part of filtrate is fed to the carbonizing tower to be carbonized, and the other part of filtrate returns back to titanium dioxide production to replace the amount of an alkaline solution required for production.

10. The production method for full resource recycling of sulphate-process titanium dioxide production wastewater according to claim 1, wherein the carbon dioxide gas adopted for carbonizing in the carbonizing tower can be a tail gas dried after titanium dioxide production, a metatitanic acid rotary kiln calcining tail gas and a carbon dioxide gas produced when wastewater is neutralized with calcium carbonate (limestone), a tail gas produced when fuel is combusted and a boiler tail gas produced in a boiler; and a carbonizing degree is controlled at the pH of 11.5-12.5, preferably 12.
